(19) United States
(12) Patent Application Publication
(10) Pub. No.: US 2014/0153029 A1
(43) Pub. Date: Jun. 5, 2014

(54) PRINTING APPARATUS, CONTROL METHOD OF THE PRINTING APPARATUS, AND STORAGE MEDIUM

(71) Applicant: CANON KABUSHIKI KAISHA, Tokyo (JP)

(72) Inventor: Aya Kasahara, Yokohama-shi (JP)

(73) Assignee: CANON KABUSHIKI KAISHA, Tokyo (JP)

(21) Appl. No.: 14/091,269

(22) Filed: Nov. 26, 2013

(30) Foreign Application Priority Data
Nov. 30, 2012 (JP) 2012-262452

(51) Int. Cl. G06K 15/02; H04N 1/00; G06K 15/00

(52) U.S. Cl. CPC G06K 15/021; G06K 15/4065; H04N 1/00278; H04N 1/00692; H04N 1/00724; H04N 1/00694
USPC 358/1.14

(57) ABSTRACT

A specific sheet is prevented from being erroneously used in a job other than a job to use the specific sheet. A method for controlling a printing apparatus including a plurality of sheet storage units for supplying a sheet and a holding unit for storing jobs in order of reception.

### BACKGROUND OF THE INVENTION

1. Field of the Invention

The present invention relates to a printing apparatus capable of processing a job using a specific sheet, a control method of the printing apparatus, and a storage medium.

2. Description of the Related Art

Conventionally, there are printing apparatuses which suspend printing if a sheet to be used in print is not included in sheets in a sheet feeding unit such as a sheet feeding cassette until the sheet feeding cassette is refilled with sheets.

For example, if a printing apparatus includes only one sheet feeding unit and a sheet to be used to a received job is not accommodated in the sheet feeding cassette, the printing apparatus suspends the printing until the sheets are refilled by a user. Then, the user confirms that the printing apparatus is running short of the sheets, refills the sheet feeding unit with the sheets to be used in printing, and causes the printing apparatus to start printing.

In addition, conventional printing apparatuses store a plurality of jobs in a storage unit and execute the jobs on a first-received and stored, first-executed basis unless it changes. (See Japanese Patent Application Laid-Open No. 11-134122.)

However, according to the conventional techniques, if a different job transmitted by another user is stored in the printing apparatus before a job transmitted by a user, a special sheet is erroneously used to the different job.

### SUMMARY OF THE INVENTION

According to an aspect of the present invention, a printing apparatus includes a plurality of sheet storage units configured to accommodate sheets, a holding unit configured to store a job, a determining unit configured to determine whether a job to be processed next is added with a suspension command for suspending a start of the job until a specific sheet can be supplied from a specific sheet storage unit, a job control unit configured to perform control, in a case wherein the determining unit determines that the suspension command is added, to process first a subsequent job which does not use the specific sheet and to suspend a start of the job added with the suspension command until the specific sheet to be used can be supplied from the specific sheet storage unit, and a printing unit configured to perform printing of the job added with the suspension command in response to a case wherein the specific sheet can be supplied from the specific sheet storage unit.

Further features of the present invention will become apparent from the following description of exemplary embodiments with reference to the attached drawings.

### BRIEF DESCRIPTION OF THE DRAWINGS

FIG. 1 illustrates an example of a printing system to which a printing apparatus is applied.

FIG. 2 is a block diagram illustrating a configuration of a printing apparatus and a computer illustrated in FIG. 1.

FIG. 3 is a flow chart illustrating a control method of a printing apparatus.

FIG. 4 is a flow chart illustrating a control method of a printing apparatus.

FIG. 5 is a flow chart illustrating a control method of a printing apparatus.

FIGS. 6A and 6B illustrate user interface (UI) screens which can be displayed on a printing apparatus according to an exemplary embodiment of the present invention.

### DESCRIPTION OF THE EMBODIMENTS

Various exemplary embodiments, features, and aspects of the invention will be described in detail below with reference to the drawings.

### <Descriptions of System Configuration>

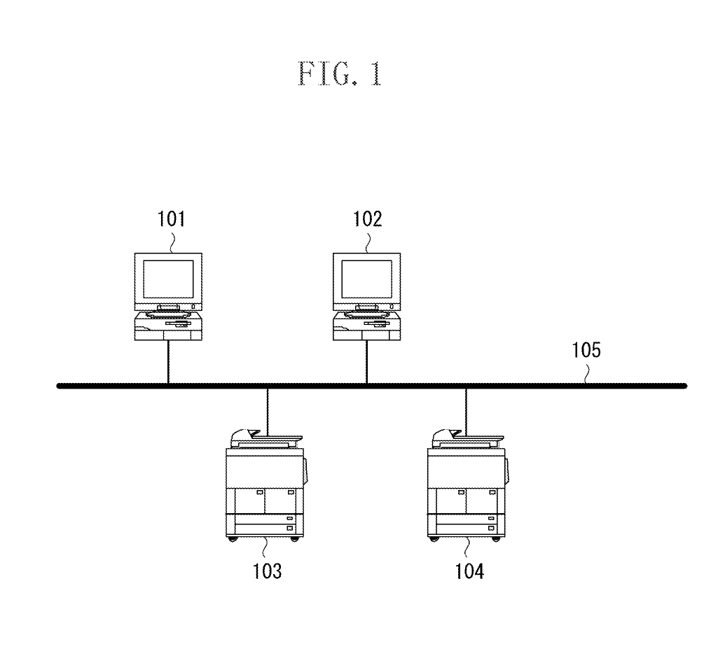

FIG. 1 illustrates an example of a printing system to which a printing apparatus according to an exemplary embodiment of the present invention is applied.

As illustrated in FIG. 1, the printing system of this example is configured with a plurality of computers 101 and 102 and a plurality of the printing apparatuses 103 and 104 which are connected via a network 105 in a bidirectionally communicable manner using a predetermined protocol. The printing apparatuses 103 and 104 include a plurality of sheet feeding cassettes for supplying sheets. Thus, if a user sets a type of sheets to be supplied from the sheet feeding cassettes individually, the user can cause the sheet feeding cassettes to function as a sheet feeding cassette for supplying normal sheets and a sheet feeding cassette for supplying specific sheets intended by the user.

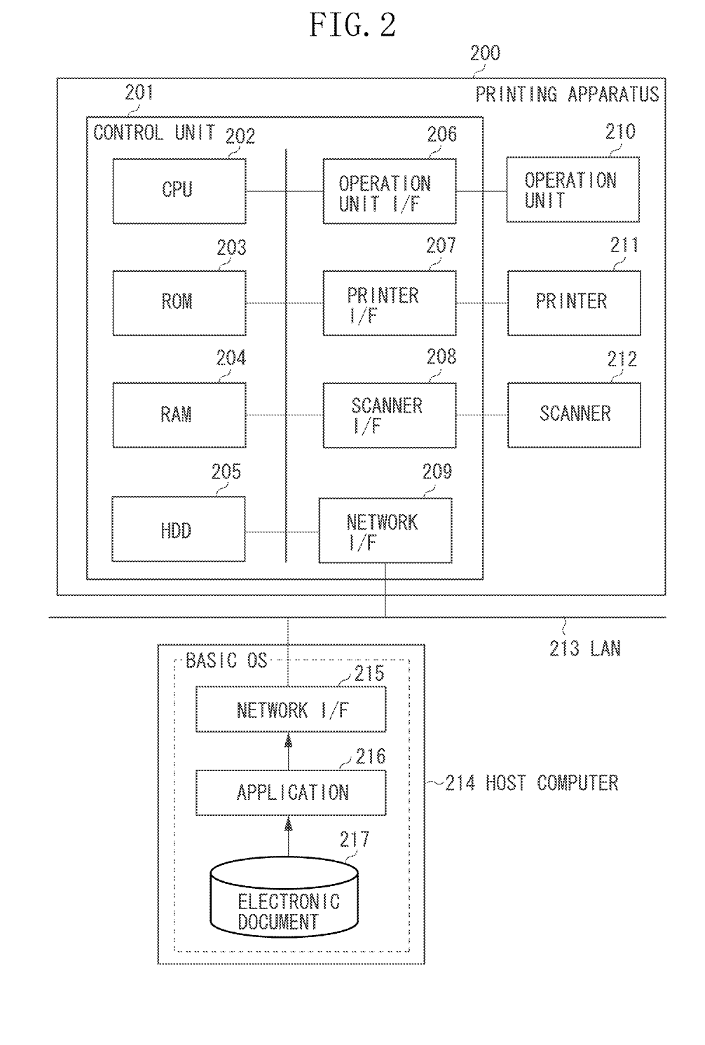

FIG. 2 is a block diagram illustrating configurations of the printing apparatuses 103 and 104 and the computers 101 and 102 illustrated in FIG. 1.

In FIG. 2, a control unit 201 including a central processing unit (CPU) 202 executes a control program stored in a read-only memory (ROM) 203 or a hard disk drive (HDD) 205 and comprehensively controls operations of the printing apparatuses 103 and 104. In addition, the CPU 202 reads out the control program stored in the ROM 203 and executes a various types of control processing, such as reading control and transmission control. A random access memory (RAM) 204 is used as a main memory of the CPU 202 and a temporary storage area such as a work area or the like. The CPU 202 is also used as a storage region for storing jobs in order of reception. The control unit may be configured to reserve the storage region in the HDD 205.

The HDD 205 stores image data, various programs, and various pieces of setting information. An operation unit interface (I/F) connects an operation unit 201 and the control unit 201. The operation unit 210 includes a liquid crystal display unit having a touch panel function, a keyboard, and the like. A printer I/F 207 connects a printer 211 and the control unit 201. Image data to be printed by the printer 211 is transferred from the control unit 201 to the printer 211 via the printer I/F 207, and printed on a recording medium by the printer 211.

A scanner I/F 208 connects a scanner 212 and the control unit 201. The scanner 212 reads an image on a document to generate image data and inputs the image data to the control unit 201 via the scanner I/F 208. A network I/F 209 connects the control unit 201 (the printing apparatuses 103 and 104) to a local area network (LAN) 213. The network I/F 209 transmits image data to an external apparatus on the LAN 213 (for example, the computer 101 or 102) and receives a print job and various information pieces from the external apparatus on the LAN 213 (for example, the computer 101 or 102).

A computer 214 is connected to the LAN 213 via a network I/F 215. The computer 214 transmits an electronic document 217 in the computer as a print job to the printing apparatus 103 or 104 via an application 216.

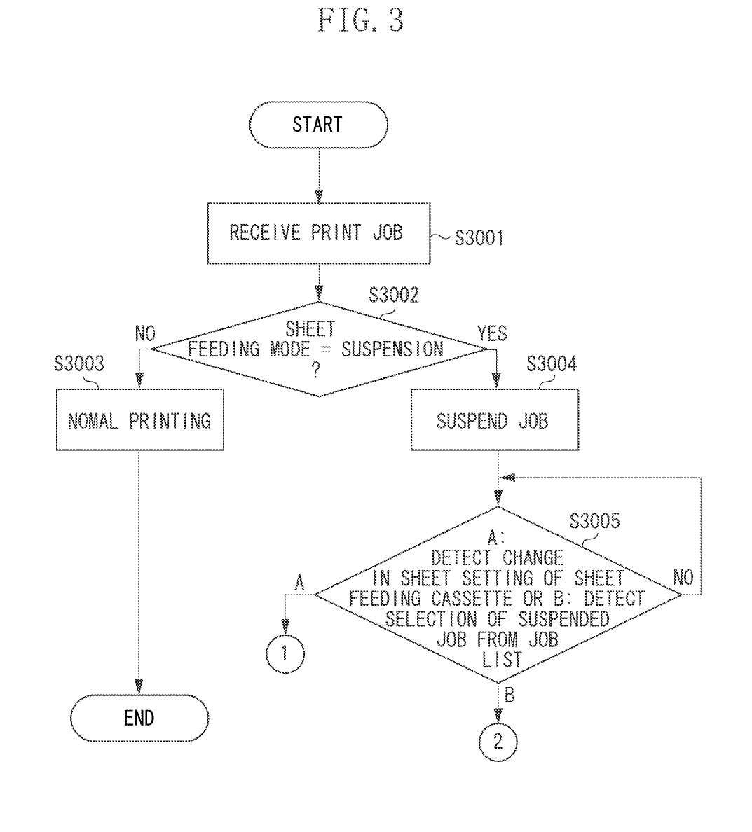

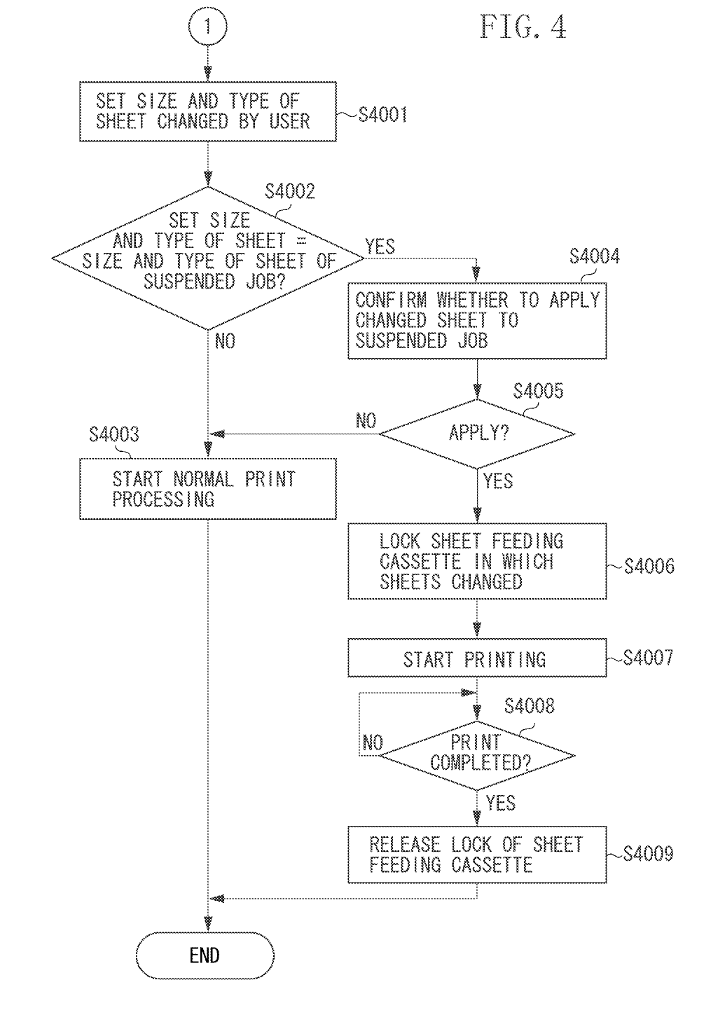

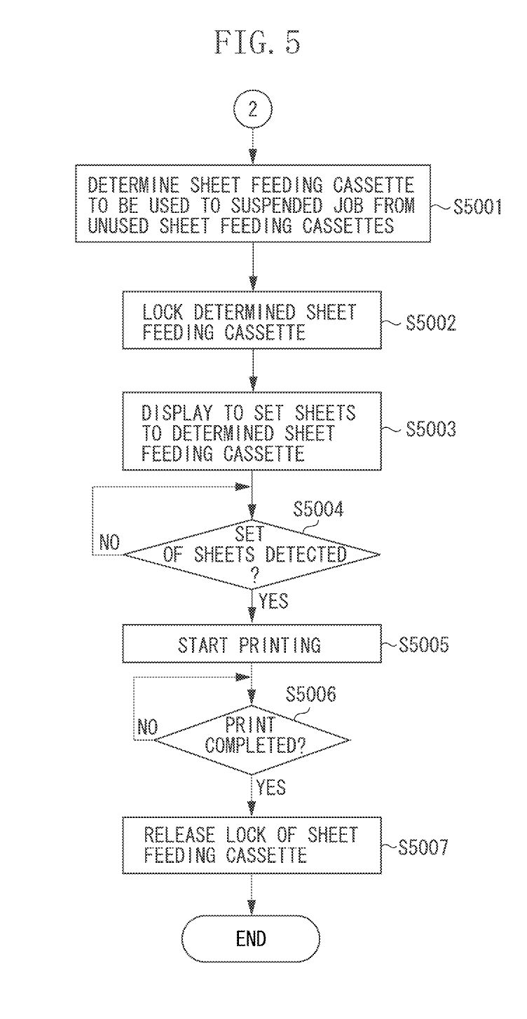

FIG. 3 is a flow chart illustrating a control method of the printing apparatus according to the present exemplary embodiment. FIG. 3 illustrates an example of control for unfailingly applying special sheets prepared by a user to a job of the user and preventing the sheets from being used in another job. Each step in the flow chart is realized by the CPU 202 executing the control program read out from the ROM 203 or the HDD 205. Hereinbelow, printing processing is described. The printing processing includes processing for determining whether a job which is stored, for example, in the RAM 204 or the HDD 205 and to be processed next includes a suspension command for postponing a start of the job until a specific sheet feeding unit becomes ready to supply specific sheets. Further, in step S3005, it is described an example of control to execute job control by switching first job control illustrated in FIG. 4 and second job control illustrated in FIG. 5.

In step S3001, the printing apparatus 103 or 104 receives a print job from the computer 101 or 102 via the LAN 213. In addition to image data, the print job includes settings for a printing layout and a sheet.

In this processing example, the processing is performed with reference to a “sheet feeding mode” and “sheet setting” included in the settings. The “sheet feeding mode” indicates whether the print job received by the printing apparatus 103 or 104 is to be subjected to printing processing immediately or to be suspended. The “sheet setting” indicates a sheet size and a sheet type used in printing.

In step S53002, the CPU 202 of the printing apparatus 103 or 104 determines whether a setting of the “sheet feeding mode” in the print job is suspension or not (the suspension command is added to the job). If the CPU 202 of the printing apparatus 103 or 104 determines that the setting of the “sheet feeding mode” in the print job is not suspension (NO ins step S3002), then the processing proceeds to step S3003. In step S3003, the printing apparatus 103 or 104 performs normal printing and ends the processing.

On the other hand, if the CPU 202 of the printing apparatus 103 or 104 determines that the “sheet feeding mode” is suspension (YES in step S3002), then the processing proceeds to step S3004. In step S3004, the CPU 202 of the printing apparatus 103 or 104 performs control to suspend the job before starting printing of the print job. When receiving a print job, the CPU 202 of the printing apparatus 103 or 104 arranges the print job in a print job execution queue in order of reception and sequentially performs printing processing from a top of the execution queue.

The CPU 202 of the printing apparatus 103 or 104 adds a job to which suspension is set in the “sheet feeding mode” to the print job execution queue similar to other print jobs. However, the CPU 202 does not perform printing processing if the suspension job comes to the top of the execution queue and performs control to execute a subsequent job by leaving the suspension job behind.

Then, in step S3005, the CPU 202 of the printing apparatus 103 or 104 performs control to store the print job suspended in step S3004 as in a suspension state in, for example, the HDD 205 of the printing apparatus 103 or 104 until occurrence of any of the following two events is detected.

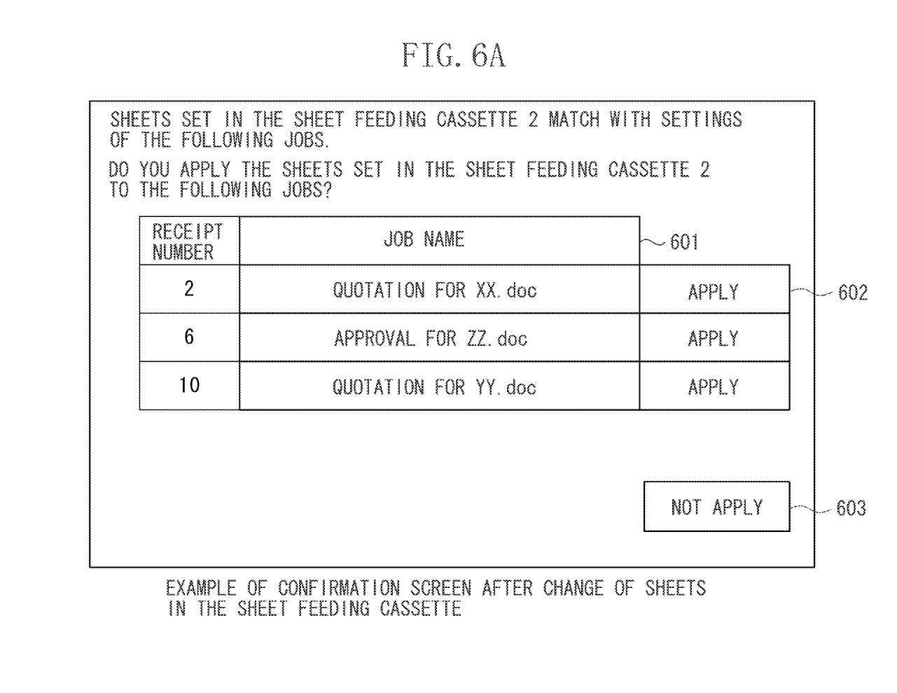

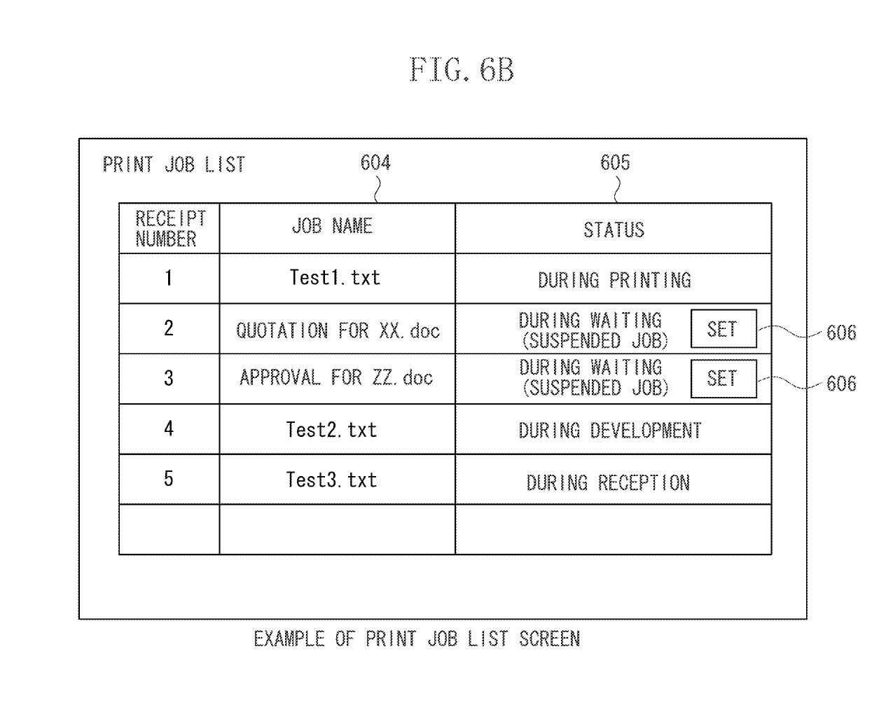

The two events are that the CPU 202 of the printing apparatus 103 or 104 detects a change of sheets in the sheet feeding cassette and that the CPU 202 of the printing apparatus 103 or 104 detects that the suspended job is selected from a job list (see FIGS. 6A and 6B) displayed on the operation unit 210.

For example, if the CPU 202 of the printing apparatus 103 or 104 detects a change in the sheet setting of the sheet feeding cassette (A in step S3005), then the processing proceeds to processing in a flow chart illustrated in FIG. 4. Whereas if the CPU 202 detects that the suspended job is selected from the job list (B in step S3005), then the processing proceeds to processing in a flow chart illustrated in FIG. 5. According to the present exemplary embodiment, if the CPU 202 determines that the suspension command is added to the job, the CPU 202 executes the first job control illustrated in FIG. 4 or the second job control illustrated in FIG. 5. The job control corresponds to processing for processing a subsequent job which does not use the specific sheet in first and suspending a start of the job added with the suspension command until the specific sheet feeding unit becomes ready for supplying the specific sheet to be used in the job.

On the other hand, the printer 211 performs printing of the job added with the suspension command in response to that the specific sheet feeding unit becomes ready for supplying the specific sheet.

FIG. 4 is the flow chart illustrating a control method of the printing apparatus according to the present exemplary embodiment. FIG. 4 illustrates an example of processing to be executed when the CPU 202 of the printing apparatus 103 or 104 detects the change in the sheet setting of the sheet feeding cassette in step S3005. Each step in the flow chart is realized by the CPU 202 executing the control program read out from the ROM 203 or the HDD 205. The various types of processing performed by the CPU 202 are described below. The various types of processing include processing executed when the CPU 202 determines, in response to that the sheet type is changed with respect to any of the sheet feeding cassettes, that a changed sheet type matches with the sheet type set in the job stored in the RAM 204 or the HDD 205. Further, the various types of processing include processing for protecting a sheet feeding cassette which supplies sheets of which type matches the changed sheet type from being selected in another job until completion of the processing of a job in which the specific sheet is supplied from the sheet feeding cassette. Furthermore, the various types of processing include the second job control for releasing the protection so that the sheet feeding cassette can be selected in the other job after the completion of the processing of the jog in which the specific sheet is supplied from the sheet feeding cassette.

In step S3005 in FIG. 3, if the CPU 202 of the printing apparatus 103 or 104 detects the change in the sheet setting of the sheet feeding cassette (A in step S3005), then the processing proceeds to step S4001 in FIG. 4 In step S4001, the CPU 202 of the printing apparatus 103 or 104 displays contents on the operation unit 210 to prompt a user to set a sheet size and a sheet type (i.e., thick paper, high quality paper, or the like) of the changed sheet using the operation unit 210.

In step S4002, the CPU 202 of the printing apparatus 103 or 104 determines whether the sheet size and the sheet type input in step S4001 match with the sheet size and the sheet type set to the suspended print job. If there is a plurality of suspended jobs, the CPU 202 performs determination on all of them.

In step S4002, if the CPU 202 of the printing apparatus 103 or 104 determines that there is no job matching in the sheet size and the sheet type (NO in step S4002), then the processing proceeds to step S4003. In step S4003, the printing apparatus 103 or 104 performs normal print processing and ends the processing. The normal print processing described here means that if there is any job in the printing apparatus 103 or 104, the printing apparatus 103 or 104 restart the processing of a job in the top of the queuing, and if there is no job, the printing apparatus 103 or 104 remains in a standby state.

On the other hand, if the CPU 202 of the printing apparatus 103 or 104 determines that there is a job matching in the sheet size and the sheet type (YES in step S4002), then the processing proceeds to step S4004.

In step S4004, the CPU 202 of the printing apparatus 103 or 104 display a user interface (UI) screen on the operation unit 210 to confirm whether to apply the sheet in the sheet feeding cassette detected in step S3005 as the sheet to be used in the suspended job which is determined that the sheet size and the sheet type are matched with the changed ones in step S4002. If the CPU 202 of the printing apparatus 103 or 104 determines that there is a plurality of suspended jobs matching in the sheet size and the sheet type, the CPU 202 of the printing apparatus 103 or 104 displays these jobs in a list. For example, the CPU 202 of the printing apparatus 103 or 104 displays a UI screen as illustrated in FIG. 6A for causing a user to select a job to which the set sheet is applied from the list.

FIGS. 6A and 6B illustrate UI screens which can be displayed by the printing apparatus according to the present exemplary embodiment. The UI screens in FIGS. 6A and 6B are examples to be displayed on a display unit of the operation unit 210 by the CPU 202. More specifically, the UI screen is an example in which a job added with a suspension command and a job not added with a suspension command are displayed in a distinguishable manner and a button for receiving settings to the job added with the suspension command is displayed.

If the CPU 202 of the printing apparatus 103 or 104 detects that a user presses a button 603 for not applying the set sheet on the displayed UI screen in FIG. 6A (NO in step S4005), the processing proceeds to step S4003 to continue the normal print processing.

On the other hand, if the CPU 202 of the printing apparatus 103 or 104 detects that a button 602 for applying the set sheet next to a job name 601 is pressed (YES in step S4005), the CPU 202 advances the processing to step S4006. Then, the CPU 202 locks the sheet feeding cassette detected in step S3005 so as not to be used in a job other than the job to which the sheet feeding cassette is set to be applied in step S4005. Accordingly, the sheets can be surely prevented from being used in the other subsequent jobs.

Then in step S4007, the CPU 202 of the printing apparatus 103 or 104 starts printing when the suspended job set in step S4005 comes the top of the print job execution queue in the printing apparatus 103 or 104.

In step S4008, if the CPU 202 of the printing apparatus 103 or 104 detects completion of the printing (YES in step S4008), the processing proceeds to step S4009. In step S4009, the CPU 202 releases the lock of the sheet feeding cassette which is locked in step S4006, and ends the processing. At that time, if the sheets are left in the locked sheet feeding cassette, the CPU 202 may display a message on the operation unit 210 for removing the sheets and release the lock after detecting the removal of the sheets. Accordingly, the specific sheets accommodated in the sheet feeding cassette can be surely prevented from being erroneously used in another job.

In addition, the CPU 202 may store a sheet size and a sheet type which are set beforehand to the locked sheet feeding cassette in a non-volatile memory (for example, a non-volatile random access memory (NVRAM), which is not illustrated) or the like, and performs control as follows. The CPU 202 may return the sheet setting of the sheet feeding cassette to the original setting of the sheet size and the sheet type at the timing when the CPU 202 confirms that a special sheet set by a user is removed.

The descriptions of processing for developing a job added with a suspension command is omitted in the above. The printing apparatuses 103 and 104 are configured to start processing for generating image data to be printed from a job in response to determination of the specific sheet feeding unit for accommodating the specific sheets in the printer 211. Accordingly, the print processing of the job added with the suspension command can be started as quick as possible.

As described above, after a user inputs a print job into the printing apparatus 103 or 104, a processing flow for setting sheets in the sheet feeding cassette in the printing apparatus 103 or 104 is controlled. Accordingly, this processing can realize control to surely apply special sheets prepared by the user to the user's job and prevent the special sheets from being used in another job.

FIG. 5 is the flow chart illustrating a control method of the printing apparatus according to the present exemplary embodiment. FIG. 5 illustrates an example of processing to be executed when the CPU 202 of the printing apparatus 103 or 104 detects that the suspended job is selected from the job list displayed on the operation unit 210 in step S3005. Each step in the flow chart is realized by the CPU 202 executing the control program read out from the ROM 203 or the HDD 205. Hereinbelow, processing for displaying a received job list including a job stored in the RAM 204 or the HDD 205 on the UI screen illustrated in FIGS. 6A and 6B is described. It is also described processing for enabling a user to determine the specific sheet feeding unit for accommodating the specific sheets to be used in the job added with the suspension command from the job list displayed on the operation unit 210. Further, it is described processing, when the specific sheet feeding cassette for accommodating the specific sheets is determined, for causing the CPU 202 to protect the determined sheet feeding cassette for supplying the specific sheets from being selected by another job until processing of a job to be supplied with the detected specific sheet is completed. Furthermore, the first job control is described which releases the protection of the specific sheet feeding unit so as to be able to be selected by the other job after the processing of the job to be supplied with the detected specific sheet is completed.

Prior to this processing, the CPU 202 displays the UI screen (a job list screen) as illustrated in FIG. 6B on the operation unit 210. In this example of the UI screen, a job status 604 is displayed next to a job name 604, and in a case of a job which is set to a suspended status in the “sheet feeding mode”, a setting button 606 is displayed.

In the UI screen, when the CPU 202 of the printing apparatus 103 or 104 detects that the setting button 606 of the suspended job is pressed in the job list displayed on the operation unit 210, the processing proceeds to step S5001.

In step S5001, the CPU 202 of the printing apparatus 103 or 104 selects an appropriate sheet feeding cassette in the printing apparatus 103 or 104 and determines to use the selected sheet feeding cassette in the suspended job.

In step S5002, the CPU 202 of the printing apparatus 103 or 104 locks the sheet feeding cassette determined in step S5001 so as not to be used in a job other then the suspended job selected in step S3005. In step S5003, the CPU 202 of the printing apparatus 103 or 104 displays, on the operation unit 210, a message for a user to set sheets to be used in the job selected in step S3005 to the sheet feeding cassette determined in step S5002.

Then, in step S5004, when the CPU 202 of the printing apparatus 103 or 104 detects that the sheets are set in the sheet feeding cassette determined in step S5002 (YES in step S5004), the processing proceeds to step S5005. In step S5005, the CPU 202 of the printing apparatus 103 or 104 starts printing when the selected suspended job comes the top of the print job execution queue in the printing apparatus 103 or 104.

Next, in step S5006, when the CPU 202 of the printing apparatus 103 or 104 determines that the printing is completed (YES in step S5006), the processing proceeds to step S5007. In step S5007, the CPU 202 releases the lock of the sheet feeding cassette which is locked in step S5002, and ends the processing.

At this time, as described in FIG. 4, if the sheets are left in the locked sheet feeding cassette, the CPU 202 may display a message on the operation unit 210 for removing the sheets and release the lock after detecting the removal of the sheets. In addition, the sheet size and the sheet type which are set beforehand to the locked sheet feeding cassette may be stored, and the CPU 202 may return the sheet setting of the sheet feeding cassette to the original setting of the sheet size and the sheet type at the timing when the CPU 202 confirms that the special sheet set by a user is removed.

As described above, after a user inputs a print job into the printing apparatus 103 or 104, a processing flow for selecting the job from the job list displayed on the operation unit 201 in the printing apparatus 103 or 104 is controlled. Accordingly, this processing can realize control to surely apply special sheets prepared by the user to the user's job and prevent the special sheets from being used in another job.

The descriptions of processing for developing a job added with a suspension command is omitted in the above, and the printing apparatuses 103 and 104 are configured to start processing for generating image data to be printed from a job in response to a change in the sheet type with respect to any of the sheet feeding units in the printer 211. Accordingly, the print processing of the job added with the suspension command can be started as quick as possible.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-262452, filed Nov. 30, 2012, which is hereby incorporated by reference herein in its entirety.

What is claimed is:

1. A printing apparatus comprising:
a plurality of sheet storage units configured to accommodate sheets;
a holding unit configured to store a job;
a determining unit configured to determine whether a job to be processed next is added with a suspension command for suspending a start of the job until a specific sheet can be supplied from a specific sheet storage unit;
a job control unit configured to perform control, in a case wherein the determining unit determines that the suspension command is added, to process first a subsequent job which does not use the specific sheet and to suspend a start of the job added with the suspension command until the specific sheet to be used can be supplied from the specific sheet storage unit; and
a printing unit configured to perform printing of the job added with the suspension command in response to a case wherein the specific sheet can be supplied from the specific sheet storage unit.

2. The printing apparatus according to claim 1, wherein the job control unit is configured to selectively execute any of first job control which is performed in response to accommodation of a specific sheet in a specific sheet storage unit and second job control which is performed in response to selection of a specific sheet storage unit for supplying a specific sheet.

3. The printing apparatus according to claim 1, further comprising:
a display unit configured to display a received job list including a job stored in the holding unit;
a specifying unit configured to specify a specific sheet storage unit which accommodates a specific sheet to be used in a job added with a suspension command from the job list displayed by the display unit; and
a detecting unit configured to detect the specific sheet is accommodated in the specific sheet storage unit specified by the specifying unit,
wherein the job control unit is configured to perform first job control, in response to a case wherein a specific sheet storage unit for accommodating a specific sheet is determined, to protect the determined specific sheet storage unit for supplying the specific sheet from being selected by another job until processing of a job supplied with a detected specific sheet is completed and to release the protection after the processing of the job supplied with the detected specific sheet is completed so that the specific sheet storage unit can be selected by the other job.

4. The printing apparatus according to claim 1, further comprising
a judging unit configured to, in response to a case wherein a sheet type is changed with respect to any of sheet storage units, determine whether the changed sheet type matches with a sheet type set to a job stored in the holding unit,
wherein the job control unit is configured to perform second job control, in a case wherein it is determined that the changed sheet type matches with the sheet type set to the stored job, to protect a sheet storage unit for supplying a sheet matching with the sheet type from being selected by another job until processing of a job supplied with a specific sheet from the sheet storage unit is completed and to release the protection after the processing of the job supplied with the specific sheet from the sheet storage unit is completed so that the sheet storage unit can be selected by the other job.

5. The printing apparatus according to claim 3, wherein
the display unit is configured to display a job which is added with a suspension command and a job which is not added with a suspension command in a distinguishable manner and display a button for receiving a setting to the job added with the suspension command.

6. The printing apparatus according to claim 3, wherein
the printing unit is configured to start processing for generating image data to be printed from a job in response to a case wherein a specific sheet storage unit for accommodating a specific sheet is determined.

7. The printing apparatus according to claim 4, wherein
the printing unit is configured to start processing for generating image data to be printed from a job in response to a case wherein a sheet type is changed with respect to any of sheet storage units.

8. A method for controlling a printing apparatus including a plurality of sheet storage units for supplying a sheet and a holding unit for storing jobs in order of reception, the method comprising:
determining whether a job to be processed next is added with a suspension command for suspending a start of the job until a specific sheet can be supplied from a specific sheet storage unit;
performing control, in a case wherein it is determined that the suspension command is added, to process first a subsequent job which does not use the specific sheet and to suspend a start of the job added with the suspension command until the specific sheet to be used can be supplied from the specific sheet storage unit; and
performing printing of the job added with the suspension command in response to a case wherein the specific sheet can be supplied from the specific sheet storage unit.

9. A computer readable storage medium for storing a computer program for controlling a printing apparatus including a plurality of sheet storage units for supplying a sheet and a holding unit for storing jobs in order of reception, the computer program comprising:
a code to determine whether a job to be processed next is added with a suspension command for suspending a start of the job until a specific sheet can be supplied from a specific sheet storage unit;
a code to perform control, in a case wherein it is determined that the suspension command is added, to process first a subsequent job which does not use the specific sheet and to suspend a start of the job added with the suspension command until the specific sheet to be used can be supplied from the specific sheet storage unit; and
a code to perform printing of the job added with the suspension command in response to a case wherein the specific sheet can be supplied from the specific sheet storage unit.
